(19) United States
(12) Patent Application Publication
(10) Pub. No.: US 2026/0093074 A1
(43) Pub. Date: Apr. 2, 2026

(54) OPTICAL FIBER CONNECTOR AND OPTICAL FIBER ADAPTER

(71) Applicant: Gloriole Electroptic Technology Corp., Kaohsiung City (TW)

(72) Inventors: Hsien-Hsin HSU, Kaohsiung City (TW); Yu-Cheng CHEN, Kaohsiung City (TW); Jim LIN, Kaohsiung City (TW)

(21) Appl. No.: 18/967,727

(22) Filed: Dec. 4, 2024

(30) Foreign Application Priority Data
Sep. 27, 2024 (TW) 113210550

(51) Int. Cl. G02B 6/38; G02B 6/24; G02B 6/36

(52) U.S. Cl. CPC G02B 6/387; G02B 6/241; G02B 6/3616; G02B 6/3644; G02B 6/3676

(57) ABSTRACT

An optical fiber connector includes a casing body, a housing, two resilient members, a tail sleeve, and an auxiliary member. The casing body includes a casing wall portion, and an engaging portion extending inclinedly from the casing wall portion, being flexible, and detachably engaging an optical fiber adapter. The housing includes two seat members defining two accommodating grooves in which the resilient members are respectively disposed. The auxiliary member includes a base portion mounted on the tail sleeve, and a drive portion extending from the base portion along a longitudinal axis and driving movement of the engaging portion. The auxiliary member is co-movable with the tail sleeve when the tail sleeve is pulled away from the casing body along the longitudinal axis such that the drive portion drives the engaging portion to move toward the casing wall portion along a height axis.

### CROSS-REFERENCE TO RELATED APPLICATION

This application claims priority to Taiwanese Utility Model Patent Application No. 113210550, filed on Sep. 27, 2024, the entire disclosure of which is incorporated by reference herein.

### FIELD

The present disclosure relates to optical fiber accessories, and more particularly to an optical fiber connector that is easy to be inserted into and removed from an optical fiber adapter, and the optical fiber adapter.

### BACKGROUND

Referring to FIGS. 1 and 2, a conventional optical fiber connector 1 includes a casing body 11, a head sleeve 12 positioned in the casing body 11, two core heads 13 mounted between the casing body 11 and the head sleeve 12 and spaced apart from each other in a top-bottom direction, a tail sleeve 14 detachably connected to a rear end of the casing body 11, a handling lever 15 disposed on the casing body 11 and extending rearwardly, and two engaging members 16 protruding upwardly from a top surface of the casing body 11. To detach the optical fiber connector 1 from an adaptor or a socket (not shown) into which the conventional optical fiber connector 1 is inserted, the casing body 11 is pulled outwardly and forcibly, such that the engaging members 16 are forced to be disengaged from engaging slots of the adaptor or the socket. However, such detaching manner may easily cause wear of the engaging members 16 or the engaging slots due to forceful pulling of the casing body 11, and the engaging members 16 may even be broken in the process.

A user may pull the handling lever 15 upwardly so the handling lever 15 and the casing body 11 are slightly deformed and moved away from the engaging members 16, thereby causing the engaging members 16 to disengage from the slots. However, the abovementioned operation manner is not specifically designed for detaching the conventional optical fiber connector 1, so relative movement between each of the engaging members 16 and the handling lever 15 may be insufficient to allow detachment of the engaging members 16 from the engaging slots. Furthermore, since a plurality of the conventional optical fiber connectors 1 are usually arranged in a matrix and are disposed in a small space, the handling lever 15 of each of the conventional optical fiber connectors 1 may be blocked by another one of the optical fiber connectors 1 or the slots, and is thus difficult to be pulled upwardly to allow detachment of the engaging members 16.

As shown in FIGS. 1 and 2, since the conventional optical fiber connector 1 is designed to be connected to a lucent (LC) ferrule, a multi-fiber (MT) ferrule 171 shown in FIG. 3 is not suitable to be connected to the conventional optical fiber connector 1. Generally, as shown in FIG. 3, the MT ferrule 171 is connected to an optical fiber cable that has twelve optical fibers 172, and the optical fibers 172 are arranged side by side. To ensure that the MT ferrule 171 is disposed in a correct position when being connected to the optical fiber cable, and to reduce excessive force applied thereto during connection, a spring 173 is utilized to provide buffering and facilitate positioning. However, due to a design of a housing of the MT ferrule 171, the spring 173 is mounted thereto by surrounding the housing in a helix, as depicted in FIG. 3, which may damage the optical fiber cable and interfere with signal transmission of the optical fiber cable.

### SUMMARY

Therefore, an object of the disclosure is to provide an optical fiber connector that can alleviate at least one of the drawbacks of the prior art.

According to an aspect of the present disclosure, an optical fiber connector includes a casing body, a housing, two resilient members, a tail sleeve, and an auxiliary member. The casing body includes a casing wall portion defining an accommodating space therein, and an engaging portion extending inclinedly from the casing wall portion away from the accommodating space, being flexible, extending substantially along a longitudinal axis, and having a distal end that is distal from and movable relative to the casing wall portion along a height axis perpendicular to the longitudinal axis. The housing includes two seat members removably mounted to the casing body and detachably connected to each other. Each of the seat members has a side wall portion extending along the longitudinal axis, an end wall portion extending from the side wall portion along a width axis perpendicular to the longitudinal axis and the height axis, and a connecting wall portion extending from the end wall portion along the height axis and abutting against the side wall portion of another one of the seat members. The side wall portions, the end wall portions and the connecting wall portions of the seat members cooperatively define two accommodating grooves extending in a direction of the longitudinal axis. The side wall portions are spaced apart from each other along the width axis and define a disposition groove extending along the longitudinal axis. The resilient members are disposed respectively in the accommodating grooves and are respectively located at two opposite sides of the disposition groove along the height axis. The tail sleeve includes a receiving portion mounted to the seat members and slidable along the longitudinal axis, and a cover portion extending from the receiving portion along the longitudinal axis in a direction away from the casing body. The auxiliary member includes a base portion mounted on the tail sleeve, and a drive portion extending from the base portion along the longitudinal axis and driving movement of the distal end of the engaging portion. The auxiliary member is co-movable with the tail sleeve when the tail sleeve is pulled away from the casing body along the longitudinal axis such that the drive portion drives the distal end of the engaging portion to move toward the casing wall portion along the height axis.

According to another aspect of the present disclosure, an optical fiber adapter is adapted to be connected to the optical fiber connector as described above. The optical fiber adapter includes a surrounding wall, an inner wall, and a plurality of limiting blocks. The surrounding wall defines therein a surrounding space extending along the longitudinal axis and having two open portions opposite along the longitudinal axis, and has a plurality of positioning holes in spatial communication with the surrounding space. The distal end of the engaging portion of the casing body of the optical fiber connector engages a selected one of the plurality of positioning holes. The inner wall is disposed in the surrounding space, is connected to the surrounding wall, and extends along the width axis. The inner wall divides the surrounding space into two insertion regions that are arranged along the longitudinal axis. The inner wall has a plurality of communication openings extending therethrough along the longitudinal axis and in spatial communication with the insertion regions. The plurality of limiting blocks protrude from the surrounding wall along the height axis into the insertion regions of the surrounding space. The plurality of limiting blocks disposed in each of the insertion regions and the surrounding wall cooperatively define a plurality of insertion slots that are arranged along the width axis and that are in spatial communication with the plurality of communication openings. Each of the plurality of insertion slots is in spatial communication with a respective one of the positioning holes.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic side view of a conventional optical fiber connector.

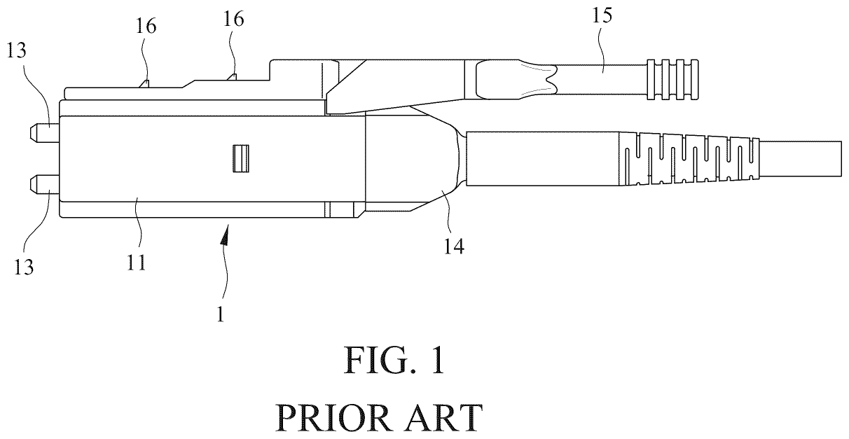

FIG. 2 is a partly exploded perspective view further illustrating the structure of FIG. 1.

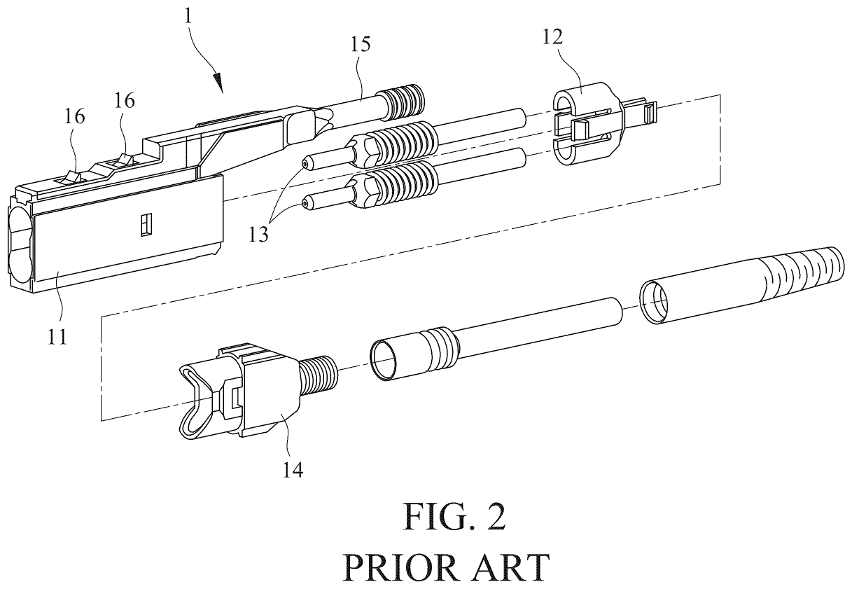

FIG. 3 is a fragmentary top view of a conventional multi-fiber (MT) ferrule.

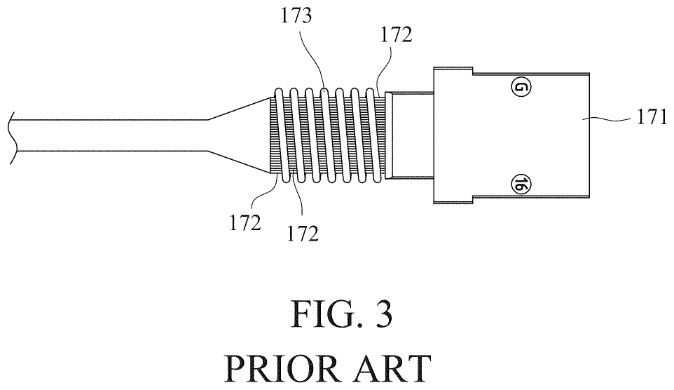

FIG. 4 is a perspective view of an embodiment of an optical fiber connector according to the present disclosure.

FIG. 5 is a partly exploded perspective view of the embodiment, illustrating relationships among components shown in FIG. 4.

FIG. 6 is a sectional view of the embodiment shown in FIG. 4.

FIG. 7 is a perspective view of a housing of the embodiment.

FIG. 8 is an exploded perspective view of two seat members of the housing seen from an angle different from FIG. 7.

FIG. 9 is a perspective view of a tail sleeve of the embodiment.

FIG. 10 is a perspective view illustrating an auxiliary member of the embodiment.

FIG. 11 is a perspective view of an embodiment of an optical fiber adapter according to the present disclosure to be connected to the optical fiber connector.

FIG. 12 is a schematic front view of the optical fiber adapter shown in FIG. 11.

FIG. 13 is a cross-sectional view of the optical fiber adapter, illustrating an interior structure thereof.

FIG. 14 is a sectional view illustrating the optical fiber connector connected to the optical fiber adapter.

FIG. 15 is a fragmentary sectional view illustrating the optical fiber connector being disengaged from the optical fiber adapter.

FIG. 16 is a perspective view illustrating a plurality of the optical fiber adapters being interconnected, with two outermost ones of the optical fiber adapters being modified.

FIG. 17 is a perspective view illustrating another modification of the optical fiber adapter.

FIG. 18 is a cross-sectional view of FIG. 17, illustrating the interior structure thereof.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

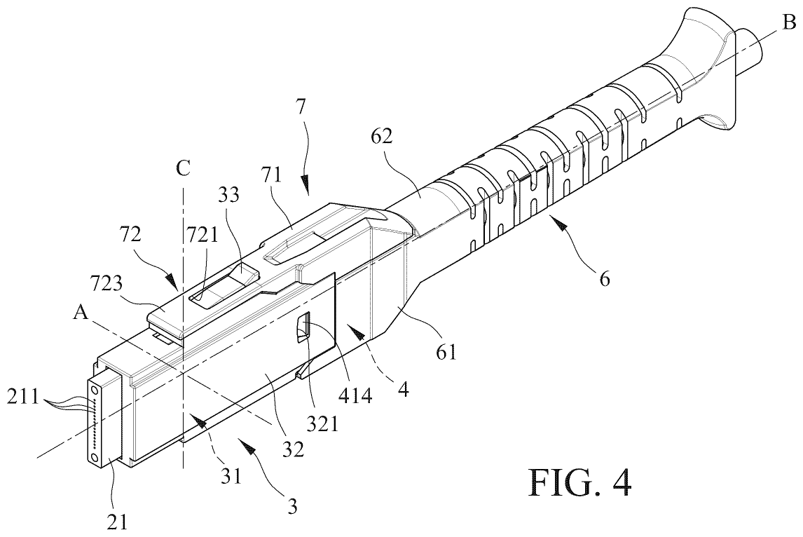

Referring to FIGS. 4, 5 and 6, an embodiment of an optical fiber connector according to the present disclosure is adapted to be connected to a core head 21 that is formed with twelve core holes 211, and an optical fiber cable 22 that has twelve optical fibers 221 respectively inserted into the core holes 211. The embodiment includes a casing body 3, a housing 4 removably mounted to the casing body 3, a protective sleeve 5 sleeved on a connecting portion of the housing 4, a tail sleeve 6 mounted to the housing 4 and covering the protective sleeve 5, an auxiliary member 7 mounted on the tail sleeve 6, and two resilient members 8 mounted in the housing 4.

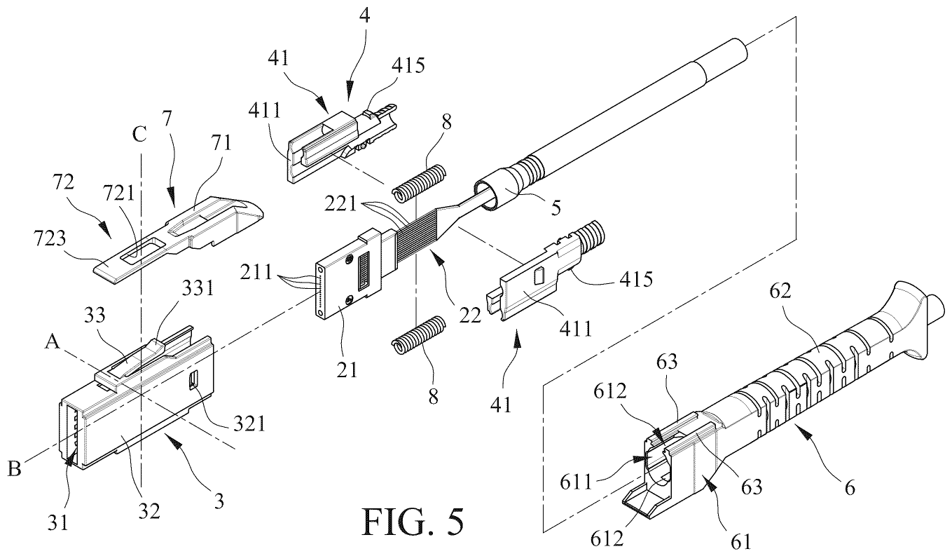

The casing body 3 includes a casing wall portion 32 defining an accommodating space 31 therein, and an engaging portion 33 extending inclinedly from the casing wall portion 32 away from the accommodating space 31 and being flexible. The casing wall portion 32 is formed with two engaging openings 321 (only one is visible in FIGS. 4 and 5) spaced apart from each other along a width axis (A) and extending through the casing wall portion 32 along the width axis (A). The engaging portion 33 extends substantially along a longitudinal axis (B) perpendicular to the width axis (A), and has a distal end 331 distal from and movable relative to the casing wall portion 32 along a height axis (C) perpendicular to the width axis (A) and the longitudinal axis (B).

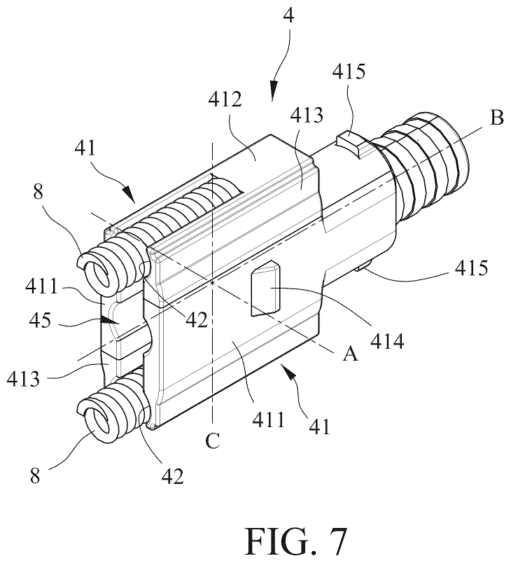

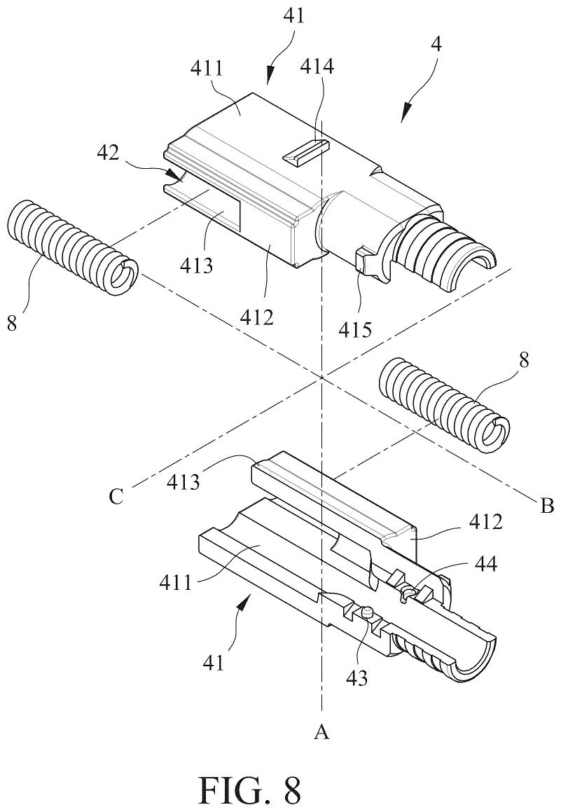

Further referring to FIGS. 7 and 8, the structure of the housing 4 is illustrated in different angles of view. FIG. 8 is an exploded perspective view of the housing 4 from an angle opposite to that of FIG. 7 along the longitudinal axis (B). The housing 4 includes two seat members 41 removably mounted to the casing body 3 and detachably connected to each other. Each of the seat members 41 has a side wall portion 411 that extends along the longitudinal axis (B), an end wall portion 412 that extends from the side wall portion 411 along the width axis (A), a connecting wall portion 413 extending from the end wall portion 412 along the height axis (C) and abutting against the side wall portion 411 of another one of the seat members 41, a fastener portion 414 protruding from the side wall portion 411 outwardly along the width axis (A) and engaging a respective one of the engaging openings 321 (see FIG. 4), and a slide piece portion 415 extending outwardly from the side wall portion 411 along the height axis (C). The side wall portions 411 of the seat members 41 have some sections disposed in the accommodating space 31, and some other sections disposed in the tail sleeve 6. The side wall portions 411, the end wall portions 412, and the connecting wall portions 413 of the seat members 41 cooperatively define two accommodating grooves 42 that extend in a direction of the longitudinal axis (B). For each of the seat members 41, the fastener portion 414 protrudes from the side wall portion 411 outwardly away from the accommodating grooves 42 along the width axis (A). As shown in FIG. 8, in this embodiment, each of the seat members 41 has a tenon 43 and a mortise 44. The tenon 43 of one of the seat members 41 engages the mortise 44 of the another one of the seat members 41, but the manner for connecting the seat members 41 is not limited hereto. The side wall portions 411 are spaced apart from each other along the width axis (A) and define a disposition groove 45 extending along the longitudinal axis (B). The disposition groove 45 is in spatial communication with the accommodating space 31, is disposed between the accommodating grooves 42 along the height axis (C), and is adapted for accommodating the core head 21 and the optical fiber cable 22 therein. The resilient members 8 are disposed respectively in the accommodating grooves 42 and are respectively disposed at two opposite sides of the disposition groove 45 along the height axis (C).

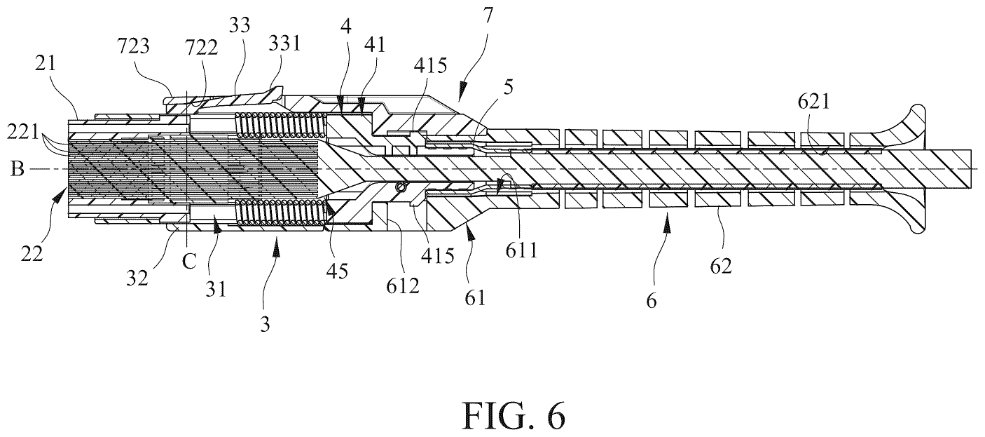

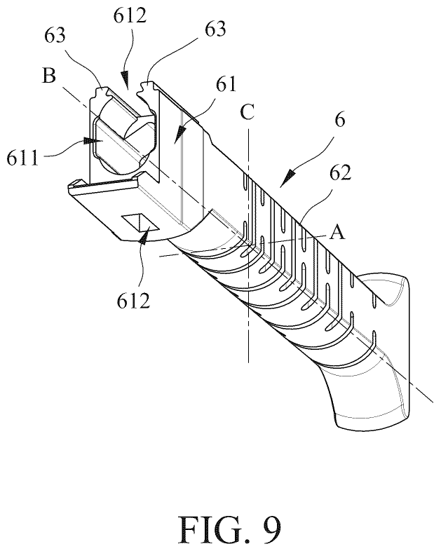

As shown in FIGS. 5 and 6, the protective sleeve 5 is sleeved on the side wall portions 411 of the seat members 41 and is away from the casing body 3 along the longitudinal axis (B). Further referring to FIG. 9, the tail sleeve 6 includes a receiving portion 61 mounted to the seat members 41 and slidable along the longitudinal axis (B), a cover portion 62 extending from the receiving portion 61 along the longitudinal axis (B) in a direction away from the casing body 3, and two slide rail portions 63 spaced apart from each other along the width axis (A), protruding from the receiving portion 61 along the height axis (C), and extending in the direction of the longitudinal axis (B). The receiving portion 61 defines an interior space 611 extending along the longitudinal axis (B), and is formed with two slide grooves 612 spaced apart from each other along the height axis (C), extending in the direction of the longitudinal axis (B), and in spatial communication with the interior space 611. For each of the seat members 41, the slide piece portion 415 extends into and is slidable relative to a respective one of the slide grooves 612. The sections of the side wall portions 411 that are not disposed in the accommodating space 31 and a portion of the protective sleeve 5 that is sleeved on the side wall portions 411 are all disposed in the interior space 611. One of the slide grooves 612 is disposed between the slide rail portions 63 along the width axis (A). The cover portion 62 defines a wire slot 621 (see FIG. 6) extending along the longitudinal axis (B) and in spatial communication with the interior space 611. The protective sleeve 5 has another portion that is not disposed in the interior space 611 and that extends through the wire slot 621 along the longitudinal axis (B).

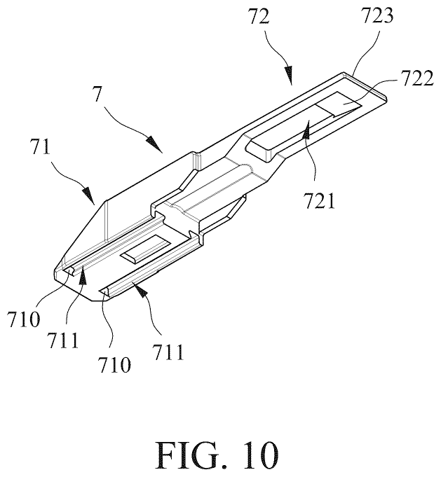

Referring to FIGS. 4 to 6 and 10, the auxiliary member 7 includes a base portion 71 disposed on the slide rail portions 63, and a drive portion 72 extending from the base portion 71 along the longitudinal axis (B). The base portion 71 defines two engaging grooves 711 respectively engaging with the slide rail portions 63. Each of the engaging grooves 711 has a closed portion defined by a terminating end surface 710 of the base portion 71 (see FIG. 10), and an open portion closer to the casing body 3 than the closed portion along the longitudinal axis (B), such that the base portion 71 is not movable relative to the tail sleeve 6 along the longitudinal axis (B) toward the casing body 3. Furthermore, the cover portion 62 abuts against the base portion 71 and blocks the base portion 71 along the longitudinal axis (B), so that the base portion 71 is prevented from moving relative to the tail sleeve 6 in a direction away from the casing body 3 (i.e., toward the tail sleeve 6) along the longitudinal axis (B). The drive portion 72 defines a slot 721 extending along the longitudinal axis (B), extending through the drive portion 72 along the height axis (C), and detachably engaging with the distal end 331 of the engaging portion 33 of the casing body 3. The drive portion 72 has a slide inclined surface 722 abutting against the engaging portion 33, and an outer surface 723 opposite to the slide inclined surface 722 along the height axis (C). A distance between the slide inclined surface 722 and the outer surface 723 along the height axis (C) is gradually reduced along the longitudinal axis (B) in a direction towards the tail sleeve 6 (see FIG. 6). In addition, the slot 721 is closer to the tail sleeve 6 than the slide inclined surface 722 along the longitudinal axis (B).

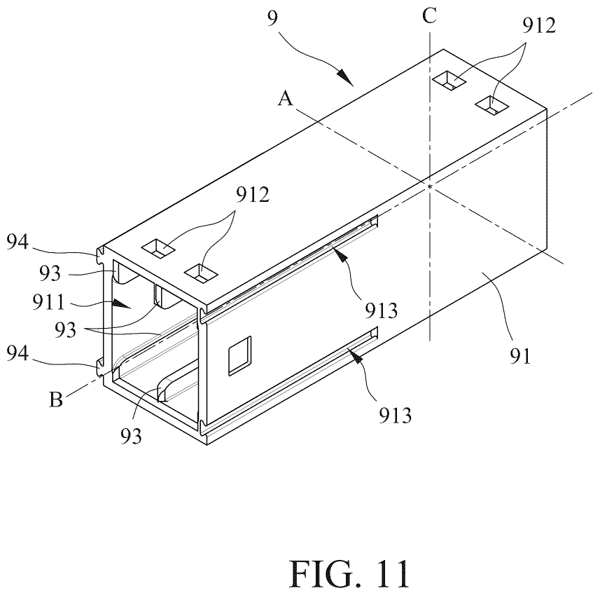

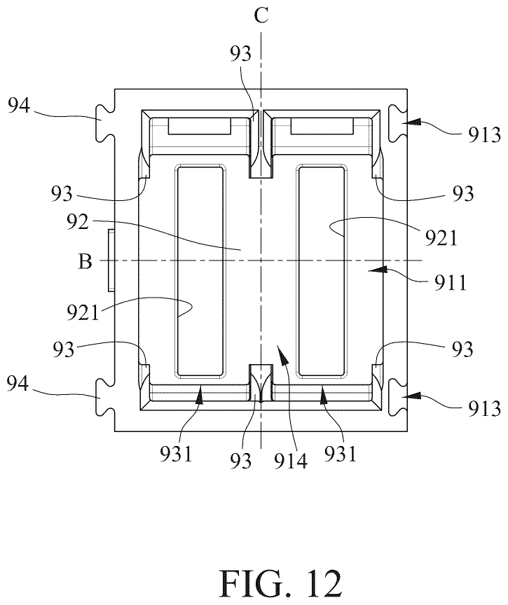

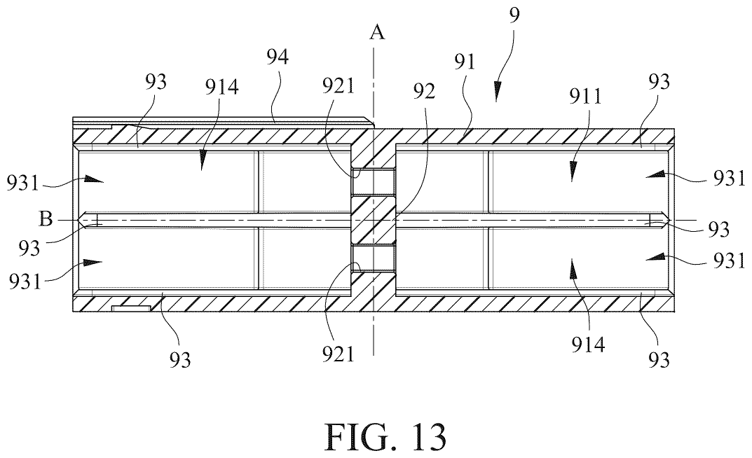

Referring to FIGS. 11 to 13, an embodiment of an optical fiber adapter 9 according to the present disclosure is to be connected to the optical fiber connector described above. The optical fiber adapter 9 includes a surrounding wall 91, an inner wall 92, and a plurality of limiting blocks 93. The surrounding wall 91 defines therein a surrounding space 911 extending along the longitudinal axis (B) and having two open portions opposite along the longitudinal axis (B). The surrounding wall 91 further has a plurality of positioning holes 912 in spatial communication with the surrounding space 911. The inner wall 92 is disposed in the surrounding space 911, is connected to the surrounding wall 91, and extends along the width axis (A). The inner wall 92 divides the surrounding space 911 into two insertion regions 914 that are arranged along the longitudinal axis (B). The inner wall 92 has two communication openings 921 extending therethrough along the longitudinal axis (B), in spatial communication with the insertion regions 914, and arranged along the width axis (A). The limiting blocks 93 protrude from the surrounding wall 91 along the height axis (C) into the insertion regions 914 of the surrounding space 911. In this embodiment, the number of the limiting blocks 93 is twelve and there are six limiting blocks 93 disposed in each of the insertion regions 914. The six limiting blocks 93 disposed in each of the insertion regions 914 and the surrounding wall 91 cooperatively define two insertion slots 931 that are arranged along the width axis (A) and that are respectively in spatial communication with the communication openings 921. In this embodiment, there are four positioning holes 912 in total disposed at the same height along the height axis (C), and four insertion slots 931 in total respectively in spatial communication with the positioning holes 912. In addition, in this embodiment, the surrounding wall 91 is a square hollow column and has an inner surface including four inner surface sections. For each of the insertion regions 914, four of the six limiting blocks 93 are respectively disposed in four inner corners of the surrounding wall 91, and each of the four of the six limiting blocks 93 is connected to two adjacent ones of the inner surface sections of the inner surface of the surrounding wall 91.

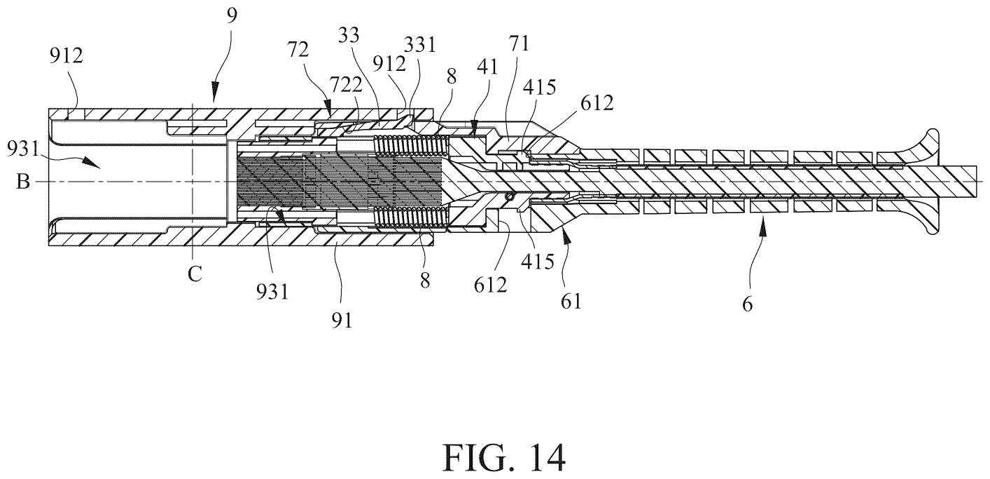

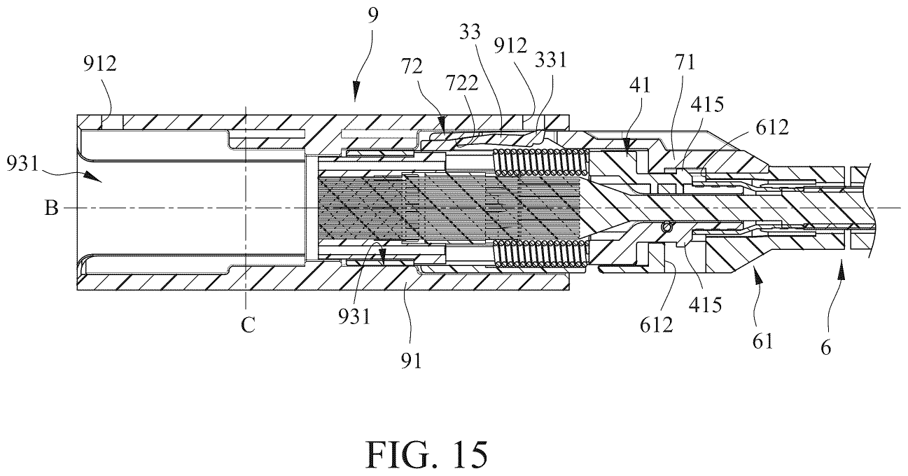

Referring to FIG. 14, the optical fiber connector of the present disclosure is inserted into the optical fiber adapter 9. Specifically, the distal end 331 of the engaging portion 33 of the casing body 3 engages a selected one of the positioning holes 912 of the optical fiber adapter 9 such that the optical fiber connector is mounted in one of the insertion slots 931. When it is desired to remove the optical fiber connector from the optical fiber adapter 9, the user only needs to grip the tail sleeve 6 and pull the same along the longitudinal axis (B) away from the casing body 3 so that the receiving portion 61 moves relative to the seat members 41 along the longitudinal axis (B) through sliding movement between the slide grooves 612 and the slide piece portions 415. Subsequently, referring to FIG. 15, when the tail sleeve 6 continuously moves away from the casing body 3, the slide rail portions 63 abut respectively against the terminating end surfaces 710 of the base portion 71 (see FIG. 10), thereby driving the base portion 71 of the auxiliary member 7 to co-move with the tail sleeve 6 away from the casing body 3. At the same time, the drive portion 72 of the auxiliary member 7 co-moves with the base portion 71, such that the slide inclined surface 722 presses the engaging portion 33 and drives the distal end 331 of the engaging portion 33 to move toward the casing wall portion 32 along the height axis (C). At this position, further referring to FIG. 15, the engaging portion 33 is slightly deformed, and the distal end 331 of the engaging portion 33 is disengaged from the slot 721 and the selected one of the positioning holes 912 and detached from the optical fiber adapter 9. In this way, the optical fiber connector of the embodiment may be detached from the optical fiber adapter 9 by continuously pulling the tail sleeve 6 along the longitudinal axis (B) away from the casing body 3. In a case where multiple optical fiber connectors are arranged densely in a matrix in a relatively small space, since any one of the optical fiber connectors can be detached from the optical fiber adapter 9 by pulling the same along the longitudinal axis (B) without operating the same along the width axis (A) and the height axis (C), it is quite simple and convenient for the user to perform the installation and deinstallation in such a relatively small space.

Referring back to FIGS. 5, 7 and 8, the disposition groove 45 is for accommodating the core head 21 and the optical fiber cable 22 therein, and the resilient members 8 are disposed outside the optical fiber cable 22, and do not surround the optical fiber cable 22. In this way, during assembly and use of the optical fiber connector, interference with signal transmission of or damage to the optical fiber cable 22 may be prevented.

In addition, in the technical field of fiber optic communication, in order to reduce energy transmission loss, surface grinding or angular grinding is usually performed on end surfaces of the optical fibers 221 of the optical fiber cable 22 so as to reduce reflection angles of optical signals transmitted therein. Accordingly, after the core head 21 is connected to the optical fiber cable 22, the end surfaces of the optical fibers 221 are ground first to reduce the reflection angles of optical signals transmitted therein, and then a grinding quality of the end surfaces of the optical fibers 221 is inspected. Subsequently, the optical fibers 221 of the optical fiber cable 22 are clamped by the seat members 41 from two sides thereof along the width axis (A), then the resilient members 8 are respectively inserted into the accommodating grooves 42, and the remaining components of the optical fiber connector are assembled. As such, before the optical fiber connector is completely assembled, the grinding quality of the end surfaces of the optical fibers 221 may be inspected, thereby avoiding the trouble of disassembling the optical fiber connector after assembling the same when the grinding quality is poor. Thus, damage to the optical fiber connector may also be prevented.

Referring to FIG. 11, in a case where a plurality of the optical fiber adapters 9 are to be connected together and are arranged along the width axis (A), for each of the optical fiber adapters 9, the surrounding wall 91 further has a plurality of connection grooves 913 formed in an outer surface of the surrounding wall 91, opposite to the surrounding space 911, and extending in a direction of the longitudinal axis (B). Each of the optical fiber adapters 9 further includes a plurality of connection tenons 94 protruding from one side of the surrounding wall 91 along the width axis (A) and respectively engaging the connection grooves 913 of an adjacent one of the optical fiber adapters 9. In this embodiment, for each of the optical fiber adapters 9, the number of the connection tenons 94 is two and the number of the connection grooves 913 is the same as that of the connection tenons 94. It should be noted that the configurations of the connection tenons 94 and the connection grooves 913 may be modified as along as the optical fiber adapters 9 are connected through engagement among the connection tenons 94 and the connection grooves 913.

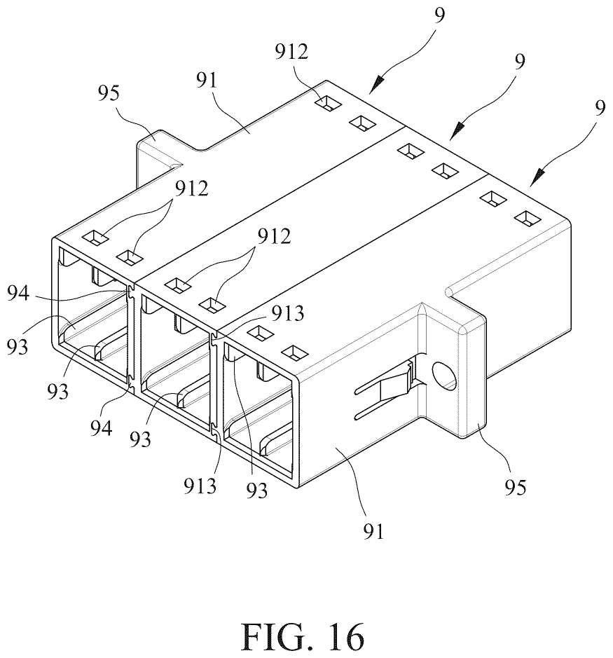

Referring to FIG. 16, two outermost ones of the optical fiber adapters 9 are modified to have a configuration different from that of the optical fiber adapter 9 shown in FIG. 11. Specifically, the connection grooves 913 are omitted in one of the outermost ones of the optical fiber adapters 9, and the connection tenons 94 are omitted in another one of the outermost ones of the optical fiber adapters 9. Each of the outermost ones of the optical fiber adapters 9 further includes a connecting lug 95 projecting from the surrounding wall 91 away from the surrounding space 911 along the width axis (A). In this modification, each of the connecting lugs 95 of the outermost ones of the optical fiber adapters 9 is formed with a through hole to be connected to a fastener such as a screw.

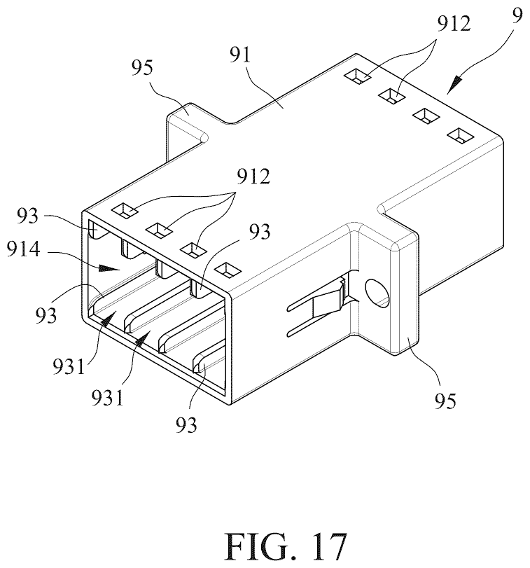

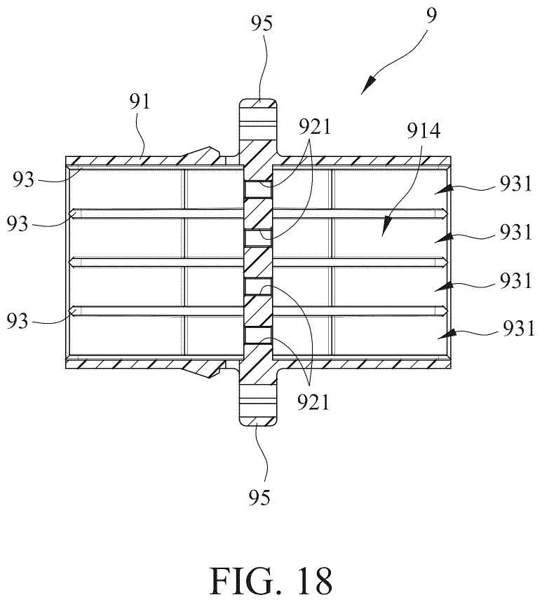

It should be noted that the number of the positioning holes 912, the communication openings 921, and the limiting blocks 93, and thus the insertion slots 931, may be modified as required. For example, referring to FIGS. 17 and 18, another modification of the optical fiber adapter 9 is shown to include two connecting lugs 95 with the connection tenons 94 and the connection grooves 913 omitted. In this modification, the surrounding wall 91 has eight positioning holes 912 in total, the inner wall 92 has four communication openings 921, the number of the limiting blocks 93 is twenty, and there are ten limiting blocks 93 disposed in each of the insertion regions 914. The ten limiting blocks 93 disposed in each of the insertion regions 914 and the surrounding wall 91 cooperatively define four insertion slots 931 that are arranged along the width axis (A) and that are respectively in spatial communication with the communication openings 921 and the positioning holes 912.

In summary, in the embodiment of the present disclosure, the engaging portion 33 may be disengaged from a selected one of the positioning holes 912 of the optical fiber adapter 9 by simple pulling of the tail sleeve 6 away from the casing body 3 without breaking any components, which is convenient for the user to operate the optical fiber connector in a relatively small space. In addition, since the seat members 41 are designed as two pieces, the optical fibers 221 of the optical fiber cable 22 may be ground prior to being clamped between the seat members 41 to be mounted in the optical fiber connector. In this way, the grinding quality of the end surfaces of the optical fibers 221 of the optical fiber cable 22 may be ensured, thereby preventing damage to the optical fiber connector caused by repeated disassembling and assembling when the grinding quality is poor. Furthermore, the resilient members 8 are disposed respectively in the accommodating grooves 42, are disposed outside the optical fiber cable 22, and do not surround the optical fiber cable 22, such that during assembly and use of the optical fiber connector, interference or damage to the optical fiber cable 22 may be prevented.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An optical fiber connector comprising:
a casing body that includes
a casing wall portion defining an accommodating space therein, and
an engaging portion extending inclinedly from said casing wall portion away from said accommodating space, being flexible, extending substantially along a longitudinal axis, and having a distal end that is distal from and movable relative to said casing wall portion along a height axis perpendicular to the longitudinal axis;
a housing that includes two seat members removably mounted to said casing body and detachably connected to each other, each of said seat members having
a side wall portion that extends along the longitudinal axis,
an end wall portion that extends from said side wall portion along a width axis perpendicular to the longitudinal axis and the height axis, and
a connecting wall portion that extends from said end wall portion along the height axis and that abuts against said side wall portion of another one of said seat members, said side wall portions, said end wall portions and said connecting wall portions of said seat members cooperatively defining two accommodating grooves that extend in a direction of the longitudinal axis, said side wall portions being spaced apart from each other along the width axis and defining a disposition groove extending along the longitudinal axis;
two resilient members that are disposed respectively in said accommodating grooves and that are respectively located at two opposite sides of said disposition groove along the height axis;
a tail sleeve that includes
a receiving portion mounted to said seat members, and slidable along the longitudinal axis, and
a cover portion extending from said receiving portion along the longitudinal axis in a direction away from said casing body; and
an auxiliary member that includes
a base portion mounted on said tail sleeve, and
a drive portion extending from said base portion along the longitudinal axis and driving movement of said distal end of said engaging portion, said auxiliary member being co-movable with said tail sleeve when said tail sleeve is pulled away from said casing body along the longitudinal axis such that said drive portion drives said distal end of said engaging portion to move toward said casing wall portion along the height axis.

2. The optical fiber connector as claimed in claim 1, wherein:
said drive portion of said auxiliary member defines a slot extending along the longitudinal axis, extending through said drive portion along the height axis, and detachably engaging with said engaging portion of said casing body;
said drive portion has a slide inclined surface abutting against said engaging portion, and an outer surface opposite to said slide inclined surface along the height axis, a distance between said slide inclined surface and said outer surface along the height axis being gradually reduced along the longitudinal axis in a direction towards said tail sleeve; and
when said base portion of said auxiliary member co-moves with said tail sleeve along the longitudinal axis away from said casing body, said slide inclined surface presses said engaging portion and drives said distal end of said engaging portion to move toward said casing wall portion along the height axis.

3. The optical fiber connector as claimed in claim 2, wherein said slot of said auxiliary member is closer to said tail sleeve than said slide inclined surface along the longitudinal axis.

4. The optical fiber connector as claimed in claim 1, wherein:
said receiving portion of said tail sleeve is formed with two slide grooves spaced apart from each other along the height axis and extending in a direction of the longitudinal axis;
said receiving portion defines an interior space in spatial communication with said slide grooves; and
each of said seat members of said housing has a side wall portion, and a slide piece portion extending from said side wall portion along the height axis, and extending into and slidable relative to a respective one of said slide grooves.

5. The optical fiber connector as claimed in claim 4, wherein:
said casing wall portion of said casing body is formed with two engaging openings spaced apart from each other along the width axis and extending through said casing wall portion along the width axis; and
each of said seat members of said housing further has a fastener portion protruding from said side wall portion away from said accommodating grooves along the width axis and engaging a respective one of said engaging openings.

6. The optical fiber connector as claimed in claim 5, wherein:
said tail sleeve further includes two slide rail portions spaced apart from each other along the width axis, protruding from said receiving portion along the height axis, and extending in the direction of the longitudinal axis;
said base portion of said auxiliary member defines two engaging grooves respectively engaging with said slide rail portions, each of said engaging grooves having a closed portion and an open portion that is closer to said casing body than said closed portion along the longitudinal axis;
one of said slide grooves is disposed between said slide rail portions along the width axis; and
said cover portion of said tail sleeve abuts against said base portion of said auxiliary member, and prevents said base portion from moving relative to said tail sleeve along the longitudinal axis.

7. The optical fiber connector as claimed in claim 4, wherein:
said cover portion of said tail sleeve defines a wire slot in spatial communication with said interior space and extending along the longitudinal axis; and
said optical fiber connector further comprises a protective sleeve having a portion that is sleeved on said housing and that is disposed in said interior space of said tail sleeve, and having another portion that extends through said wire slot along the longitudinal axis.

8. An optical fiber adapter adapted to be connected to said optical fiber connector as claimed in claim 1, said optical fiber adapter comprising:
a surrounding wall that defines therein a surrounding space extending along the longitudinal axis and having two open portions opposite along the longitudinal axis, and that has a plurality of positioning holes in spatial communication with said surrounding space, said distal end of said engaging portion of said casing body of said optical fiber connector engaging a selected one of said plurality of positioning holes;
an inner wall that is disposed in said surrounding space, that is connected to said surrounding wall, and that extends along the width axis, said inner wall dividing said surrounding space into two insertion regions that are arranged along the longitudinal axis, said inner wall having a plurality of communication openings extending therethrough along the longitudinal axis and in spatial communication with said insertion regions; and
a plurality of limiting blocks that protrude from said surrounding wall along the height axis into said insertion regions of said surrounding space, said plurality of limiting blocks disposed in each of said insertion regions and said surrounding wall cooperatively defining a plurality of insertion slots that are arranged along the width axis and that are in spatial communication with said plurality of communication openings, each of said plurality of insertion slots in spatial communication with a respective one of said positioning holes.

9. The optical fiber adapter as claimed in claim 8, wherein:
said optical fiber adapter includes a plurality of said optical fiber adapters;
for each of said plurality of optical fiber adapters, said surrounding wall has a plurality of connection grooves formed in an outer surface of said surrounding wall, opposite to said surrounding space, and extending in a direction of the longitudinal axis;
each of said plurality of optical fiber adapters further comprises a plurality of connection tenons protruding from said surrounding wall away from said surrounding space along the width axis and respectively engaging said plurality of connection grooves of an adjacent one of said plurality of optical fiber adapters.

10. The optical fiber adapter as claimed in claim 8, wherein:
said optical fiber adapter includes a plurality of said optical fiber adapters; and
each of two outermost ones of said plurality of optical fiber adapters further comprises a connecting lug projecting from said surrounding wall away from said surrounding space along the width axis.

11. The optical fiber adapter as claimed in claim 8, wherein:
said optical fiber adapter further comprises two connecting lugs projecting from said surrounding wall away from each other along the width axis.
